(19) United States
(12) Patent Application Publication
(10) Pub. No.: US 2008/0097797 A1
(43) Pub. Date: Apr. 24, 2008

(54) RETIREMENT COMPENSATION AGREEMENT FINANCING SYSTEM AND METHOD

(76) Inventors: Garnet G. Morris, Saskatchewan (CA); Wilson H. Olive, Saskatchewan (CA); Allan E. Reznick, Chappaqua, NY (US)

Correspondence Address: Jonathan S. Caplan, Esq.;Kramer Levin Naftalis & Frankel LLP, 919 Third Avenue, New York, NY, 10022, US

(21) Appl. No.: 11/959,024

(22) Filed: Dec. 18, 2007

Related U.S. Application Data
(63) Continuation of application No. 09/607,891, filed on Jun. 30, 2000.

(51) Int. Cl. G06Q 40/00

(52) U.S. Cl. 705/4; 705/37; 705/39

(57) ABSTRACT

A retirement compensation arrangement (RCA) leveraged loan portfolio is created and debt instruments secured by the RCA leveraged loan portfolio are sold in a public or private offering. The fixed rate or floating rate debt instruments secured by the RCA leveraged loan portfolio provide investment access to high quality insurance policies and rights to monies in refundable government tax accounts.

### FIELD OF THE INVENTION

The present invention relates to retirement compensation arrangement financing and more particularly, to a system and method for offering public or privately placed debt securities secured by these assets.

### BACKGROUND INFORMATION

In Canada, retirement compensation arrangement (RCA) accounts were established in 1986 by the Canadian government's Taxation authorities. A RCA is a plan or arrangement under which an employer makes contributions to another person, referred to as a “custodian,” to fund retirement benefits payable to an employee. The contribution by the employer is subject to a 50% recoverable tax held in a non-interest bearing account by the government.

Generally, a RCA works as follows. When a company, for example a closely held corporation, a publicly traded corporation or a private business, desires to fund a supplemental pension plan for the owner or shareholders, executives or senior managers, it may do so by making a deposit into a RCA account. A distribution in the form of a bonus, salary payout or contribution to a supplemental pension plan is an expense to the company that may be deducted from the company's earnings. Distribution from the companies are subject to the beneficiary's individual tax rate, which in many provinces of Canada can be 50% or more.

To offset the financial burden inherent in funding a supplemental executive pension and to finance the growth or operations of the company, an owner/manager or other beneficiary of a supplemental pension contribution may wish to loan all or part of the proceeds of this contribution back to the company. Unless this is accomplished in a tax-efficient manner, the company will not receive the full benefit that such a transaction contemplates.

In order to address this situation, in certain circumstances the RCA has been used to enhance the long-term retirement issues for owners and senior managers of the company. In order that the company not impair its cash flow, it borrows back a portion of the contribution from the RCA in a loan-back transaction. FIG. 1 illustrates an exemplary prior art method for using a RCA to fund an executive pension without impairing the company by loaning a portion of the distribution back to the company.

As illustrated in FIG. 1, a company, referred to as Opco 110, creates an obligation to fund a pension for an executive or shareholder. For example, Opco 110 may have a net profit to distribute or simply desires to make a contribution to a pension plan. For purposes of example, assume that Opco 110 has $4,000,000 available to fund a pension. Using the RCA facility established by Revenue Canada, 50% of the amount to be contribution to the pension from Opco 110 is paid into a RCA trust account 130 and 50% is paid into a non-interest bearing refundable tax account 120 maintained by Revenue Canada. According to Revenue Canada regulations, 50% of all distributions to a RCA account and all taxable earnings on those funds while in that account must be paid into such a refundable tax account 120 maintained by Revenue Canada. When money is eventually distributed from the RCA trust account 130 to the beneficiary of the account, money can be withdrawn from the Revenue Canada refund tax account 120, for example at the rate of $1 from the Revenue Canada account 120 for every $2 from the RCA trust account 130. A benefit to the employee receiving a contribution to a RCA pension plan rather than saving funds from a tax paid bonus is that the 50% distribution sent to the Revenue Canada account 120 is recoverable when the RCA funds are withdrawn and retaxed whereas a conventional distribution from Opco would generally give rise to an immediate tax liability; this could allow an executive to pay tax at a lower rate in the future.

FIG. 2 illustrates an exemplary flowchart for a prior art leveraged RCA loan. At 2010, a company, again referred to as Opco, determines to make a contribution to a retirement compensation agreement (RCA) account on behalf of the owner, certain highly compensated employees of Opco or certain shareholders of Opco. At 2020, 50% of the contribution is sent to a Revenue Canada non-interest bearing refundable tax account. At 2030, the remaining 50% of the contribution is sent to a RCA trust account established for the beneficiary. Multiple RCA accounts and refundable tax accounts could be established if there were multiple beneficiaries. As is known in the art, applicable guidelines determine the amount that can be contributed to a RCA for a particular beneficiary. For example, the amount to be contributed is related to what represents a reasonable executive pension based on a number of factors such as length of service, the income of the recipient, the industry involved and an actuarial calculation of what amount should be contributed for future service.

At 2040, the RCA account acquires an insurance policy having, for example, a cash surrender value (CSV) equal to the amount of the contribution to the RCA account. For example, if Opco has $4,000,000 to distribute using the RCA, then $2,000,000 would be sent to Revenue Canada at step 2020 and the remaining $2,000,000 would be sent to the RCA account at 2030. The $2,000,000 received by the RCA account is used, at 2040, to purchase an insurance policy, such as a universal life insurance policy on the life of the beneficiary of the distribution, that has an immediate CSV equal to $2,000,000. A CSV of $2,000,000 allows, at 2050, a loan to be obtained by the RCA account from a lending institution in the amount of, for example, up to 90% of the sum of the CSV and the value of the refundable tax account. In this example, a loan of $3,600,000 could be obtained based on the $4,000,000 contribution from Opco. The 90% leverage is possible because the collateral that exists for the loan such as the insurance policy (e.g., which has a CSV of the full contribution to the RCA account) and a general security agreement over the assets of the RCA Trust coupled with the right to designate the trustee of the RCA trust and thereby cause the Trustee to file for a refund of the tax deposit thereby acquiring such funds within the RCA trust which are subject to the general security agreement.

For example, the security provided by the RCA Trust to the lending institution can include: a standard loan agreement acceptable to the lending party containing standard representation, warranties, covenants and events of default; a promissory note in the amount of the loan; a general security agreement; an assignment of the RCA Trust's interest in the insurance policy (CSV and death benefits); and an assignment of loan obligations from a third party used to facilitate the transaction as described below.

At 2060, the $3,600,000 loan from the lending institution can be loaned backed to Opco In this example, the $3,600,000 loan is backed by $2,000,000 in assets in the insurance policy and contractual rights to any refunds to the RCA from the refundable tax account. The loan back to Opco is routed, for example, through a private investment company held by the manager or owners of Opco, referred to herein as Investco, as shown in FIG. 1. Thus, Opco can fund an executive pension for the executive beneficiary with minimized cash loss consequences and the beneficiary can direct a significant portion of the RCA contribution to be loaned back to Opco at competitive rates.

In the event of default, the lending party would realize on the CSV of the insurance policy. The RCA Trust would, for example, sell the promissory note held from Investco to the lending party at fair market value by way of a put agreement. The lender would seize these funds. Assuming money was still owed to the lending party and no other assets for the RCA Trust exist besides the value of the refundable tax account, then the RCA Trust can pursue all or a portion of the refundable tax from the refundable tax account from Revenue Canada and use those funds to retire any outstanding balance owing under the loan. The lender would be entitled to realize on these funds by virtue of the General Security Agreement.

As mentioned above, the insurance policy or contract acquired by the RCA trust account 130 has a cash surrender value of at least the total amount placed into the RCA trust account. When financial institution 140 loans 90% of the contribution amount from Opco 110 to the RCA trust 130, the loan may be, for example, a secured loan at a rate as set by the lender based on, for example, commercial paper, prime rate or bankers acceptance, with interest only payments during the term of the loan, the entire principal being due at the end of the loan term. As described above, the loan is secured by the CSV and death benefit of the insurance policy acquired by the RCA trust 130 and a right to proceeds from the refundable tax account 120 received by the RCA Trust upon default. The RCA trust 130 then can loan the money it borrows from lending institution 140, in this example, $3,600,000, to Investco 150 at a first rate, for example prime plus 34%, with security noted above. In turn, Investco 150 loans the $3,600,000 to Opco 110 at, for example, a second rate higher than that paid by the RCA Trust, for example, prime plus 1¼%. The spread between rates is designed to offset the administrative expenses that arise at each stage of the transaction.

FIG. 3 illustrates an exemplary prior art insurance policy summary for a universal life policy purchased by a RCA trust account 130. The illustration in FIG. 3 shows an exemplary summary for an individual, in this case a 55 year old non-smoker male, where a $4,000,000 contribution to a pension plan from Opco has occurred, $2,000,000 (50% of the $4,000,000 distribution) has been transferred to a RCA trust account and a universal life insurance policy is acquired by the RCA trust. As shown in FIG. 3, columns 301 and 302 show the year of the policy and the age of the insured, respectively. Column 303 shows the interest earned on deposits that will be contributed to the insurance policy contract in the future. They are stored in an investment account. These funds cannot be immediately placed into the insurance policy due to, for example, regulatory limits (e.g., the Canadian Income Tax Act) on the amount of investment money that can be placed into an insurance policy as a function of the amount of death benefit purchased and still maintain the exempt status of the policy. For example, if too much money is in the insurance policy, accrual taxation can be assessed against all of the funds being invested in the policy (e.g., if the policy loses its tax-exempt status). The amount of money that can be put into an insurance policy and grow exempt from, for example, accrual taxation is prescribed by applicable insurance and taxation regulations.

Column 304 of FIG. 3 shows the cumulative amount transferred to the refundable tax account with Revenue Canada. As illustrated for this example, initially $2,000,000 is placed into the refundable tax account and in each of years 2-6, 50% of the interest earned on the money in the side account, shown in column 303, is remitted to the refundable tax account. Column 305 illustrates the cumulative value of contributions to insurance, which matches the values in column 304 since all taxable monies earned after purchase of the insurance policy are split evenly between the refundable tax account and the insurance policy.

Column 306 of FIG. 3 illustrates the cash value of the insurance policy which matches the cash surrender value of the policy. Column 306 includes, for example, the value of the funds growing exempt from accrual taxation within the insurance policy and any side account value. As will be explained with regards to FIG. 8, it may take several years to get all of the initial $2,000,000 deposit into the insurance policy even though the entire $2,000,000 may be paid to the insurance company at the inception of the insurance policy pursuant to a contractual agreement. In addition, column 306 illustrates the value of the policy after deductions for industry-standard penalties for termination of the policy which are in force for the first several years of the policy.

Column 307 is the total RCA asset value, which is the sum of columns 305 and 306. Column 308 is the total value of the RCA death benefit, that is the value of the portion of the insurance policy owned by the RCA trust upon the death of the insured. The death benefit owned by the RCA Trust rises and falls to allow money to be moved into the tax-exempt fund of the policy, further described below. Column 310 is the value of the death benefit owned by Investco, which is equal to the leveraged loan amount and in this example is $3,600,000 and is in addition to death benefit owned by the RCA Trust. The value of the Investco-owned death benefit is, for example, constant for the duration of the leveraged loan transaction and the premium for the death benefit is paid by Investco annually, the amount being shown in column 309. In the present example, a ten year level term policy and a follow-on five year level term policy are used to determine the notional value for the death benefit premium to be paid by Investco. The term insurance policies utilized by Investco can vary as a function of the age, sex and health condition of the insured as well as the term of the loan to the RCA Trust. For example, once the loan is repaid, in this example at year 15, it is no longer necessary for Investco to purchase death benefit insurance.

The death benefit of the insurance policy must be equal to or greater than the leveraged loan amount to Opco until the loan is paid off. The amount of death benefit in the insurance policy is kept to the minimum amount to cover the leveraged loan amount and to meet the minimum requirements for death benefits allowed by applicable insurance regulations. Minimizing the amount of death benefit minimizes the cost of insurance and allows the maximum amount of money to grow exempt from accrual taxation in the insurance policy to optimize the funding of the insured's retirement.

As described above, the annual death benefit payment may be made by Investco. For example, while the RCA trust 130 owns the life insurance policy, the RCA trust's primary interest is in the cash value of the policy since the CSV is used to fund the retirement option and is pledged as security for the loan from the lending institution; the death benefit is not needed by the RCA trust. On the other hand, Investco is responsible for repayment of the principal amount of the loan upon default by Opco.

Accordingly, Investco can buy some of the death benefit portion of the insurance policy and assign the death benefit to the lending institution to cover the debt. This is considered, for example, an external transaction to the RCA. This creates, for example, a split dollar policy where the RCA trust owns the cash value of the insurance policy and Investco owns some of the death benefit of the insurance policy. However, the death benefit paid for by Investco is part of a single universal life insurance policy.

FIG. 4 illustrates another exemplary illustration for a prior art insurance policy further detailing the summary illustration shown in FIG. 3. Columns 401 and 402 show the year of the policy and the age of the insured, respectively. Column 403 shows the deposits to the policy of the amounts collected by the policy from Investco for the death benefits noted above. For example, the $14,126 shown for years 1-10 is the amount paid by Investco for the portion of the death benefit portion of the policy, in this case $3,600,000 of death benefit to cover the principal owed on the leveraged RCA loan. The cost of this death benefit component of the insurance policy can be fixed over the first ten years, for example using a notional ten year term cost to calculate the cost of the death benefit. The notional value is based on, for example, the cost of a ten year level term insurance policy in the marketplace at the time of the transaction from a company of like financial solvency.

To the extent there is a shortfall between the actual cost of the death benefit insurance and the notional value shown in FIG. 4, the difference would be taken from the fund value, illustrated in column 406. The term that Investco pays for a portion of the death benefit may be commensurate with the anticipated term of the loan from the lending institution. Column 405 illustrates the total value of the policy exclusive of the side account, that would be paid out on the death of the insured and it includes the cash or fund value. Column 406 shows the fund value of the exempt deposits into the insurance policy plus exempt interest earned after deduction of expenses and investment income tax by the insurance company.

As indicated above, the initial $2,000,000 deposit cannot all be used to purchase an insurance policy having a death benefit of only, for example, $3,600,000 as used in the present example. If all of the funds were put into the policy at inception, regulations would require significantly more death benefit than is appropriate for the transaction. Therefore, to put the entire $2,000,000 into a universal life insurance policy and immediately attain tax free growth of the investment in the insurance policy, approximately $12,000,000 of death benefit (this amount will vary as a function of the insurer's age, sex, health status, etc.) would be required, which is significantly more death benefit than required for the transaction. Since all of the initial $2,000,000 cannot be placed into the insurance policy, column 407 shows the portion of the initial $2,000,000 that has to wait in a side account until additional money can be put into the policy. The reason a larger death benefit is not used is because it would greatly increase the insurance charged levied against the cash value and thus increase the ultimate benefit to the beneficiary of the RCA.

As is known in the art and set forth in applicable regulations, each year on the policy anniversary of a universal life insurance policy additional money may be placed into the policy's tax-exempt investment portion. As shown in FIG. 4, only about $211,000 of the initial deposit can be put into the insurance policy while at the outset about $1,880,000 remains in a side account for the present example. The amount in column 406 grows tax-exempt. Column 303 of FIG. 3 shows the taxable interest earned on the side account amount shown in column 407 in FIG. 4. Column 408 is the cash surrender value (CSV) of the insurance policy which equals the sum of columns 406 and 407. During, for example, the first ten years of the insurance policy, however, the CSV is less than the sum of columns 406 and 407 which reflects a reduction for the termination fees charged by the insurance company issuing the policy in the event of early termination of the policy.

For example, to allow the sum of the CSV and the side account of the insurance contract (e.g., the insurance policy and the management of any additional funds that cannot be put into the insurance policy at inception) to be equal to the contribution into the RCA trust account from Opco at inception, the insurance carrier may waive or reduce the surrender charge for the first year to ensure that the cash surrender value in the first year of the policy equals at least the amount deposited into the policy (e.g., $2,000,000 in the current example). Since a bank generally only loans based on cash value, any surrender charges would be subtracted from the fund value (the tax exempt amount in the insurance policy) thus reducing the amount that can be leveraged by the RCA Trust. For example, the first year surrender charge for the exemplary universal life insurance policy may be $55,000 and could present a shortfall in the desired CSV being satisfied if this charge were not waived. After the first year, the value of the policy increases (e.g., the fund value and interest on the side account) sufficiently to overcome the surrender charges, even where the surrender charges increase to $110,000 in year two and $165,000 in year three. Once the surrender charge period ends, usually 8-10 years from policy inception, the CSV increases to the same value as the fund value shown in column 406. The CSV is the amount that can be leveraged by the policyholder, in this case the RCA trust.

To facilitate getting as much of the side account value into the policy as quickly as possible, the insurance carrier may include, for example, an increase/decrease feature which increases the amount of death benefit by, for example, a predetermined percentage, generally regulated by applicable tax law, which increases the amount of cash that can be brought into the investment portion of the insurance policy. In addition, on the anniversary of the policy an additional deposit into the insurance policy is allowed based on a standard industry test. Accordingly, the death benefit value shown in column 405 of FIG. 4 and column 608 in FIG. 3 increases, for example by 8% per year until all of the side account monies have been brought into the policy as permitted by applicable regulations. Once all of the side account money is in the insurance policy, the death benefit amount can be decreased as quickly as possible to get the death benefit down as close as possible to the desired amount, $3,600,000 in this example. This maximizes the returns to the beneficiary as it minimizes the charges for death benefit.

Once the RCA distribution is made and a suitable insurance policy acquired, the RCA trust account 130 can arrange for a loan from a lending institution, such as bank 140, providing as collateral the insurance policy held by the RCA trust account 130 as well as the right to monies received by the RCA trust from the refundable tax account 120. Accordingly, the RCA trust 130 can obtain a loan for up to 90% of the total contribution from Opco 110 and arrange to further loan this amount back to Opco 110. The amount of the distribution into the RCA trust account that can be leveraged for the loan depends on the type of investment selected by the RCA trust account and the lending criteria of the lending institution.

For example, if the insurance policy purchased by the RCA trust account 130 is provided by an AAA rated insurance company and the funds deposited into a fixed income type deposit, maximum leverage can be obtained for a bank loan utilizing the insurance policy and the right to monies received by the RCA trust from the refundable tax account as collateral. Once the RCA trust account 130 receives the loan from bank 140, the RCA trust 130 can loan the entire amount back to Opco 110 via Investco. As will be appreciated, the loan rate between each party to the transaction can be increased slightly to cover the transaction expenses, legal fees, administrative fees, and increased risk factors associated with the transaction.

It would be desirable to aggregate multiple leveraged RCA loans to support public or privately placed debt securities. In addition, it is desirable to allow investors to have debt exposure to the claims paying ability of highly rated insurance companies rather than to the debt directly issued by such companies and which is subordinated to their liabilities to policy holders. As a practical matter, there is no direct exposure to the claims paying ability of insurance companies available in the capital markets.

### SUMMARY OF THE INVENTION

A retirement compensation arrangement leveraged loan portfolio is created and debt instruments secured by the retirement compensation arrangement leveraged loan portfolio can be sold in the capital markets through a public or private offering. Fixed rate or floating rate debt securities are secured by high quality insurance policies and loan collateral providing access to refundable government tax accounts.

### BRIEF DESCRIPTION OF THE DRAWING

FIG. 1 illustrates a prior art model for a leveraged retirement compensation agreement loan transaction.

FIG. 2 illustrates an exemplary flowchart for a prior art leveraged loan transaction.

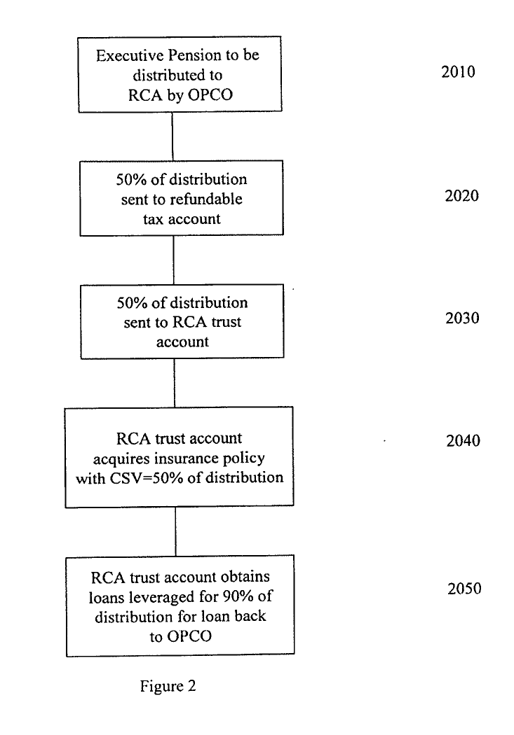

FIG. 3 illustrates an exemplary prior art insurance policy illustration.

FIG. 4 illustrates another exemplary illustration for a prior art insurance further detailing the summary illustration shown in FIG. 3.

FIG. 5 illustrates an exemplary block diagram for a system for offering debt instruments based on a leveraged loan transaction according to an embodiment of the present invention.

FIG. 6 illustrates another exemplary block diagram for a system for offering debt instruments based on a leveraged loan transaction according to an embodiment of the present invention.

FIG. 7 illustrates an exemplary flowchart for a securitized debt offering according to an embodiment of the present invention.

FIG. 8 illustrates an exemplary insurance policy illustration according to an embodiment of the present invention.

FIG. 9 illustrates another exemplary insurance policy illustration according to an embodiment of the present invention.

FIG. 10 illustrates an alternative embodiment for a system for offering debt instruments based on a leveraged loan transaction according to an embodiment of the present invention.

### DETAILED DESCRIPTION OF THE INVENTION

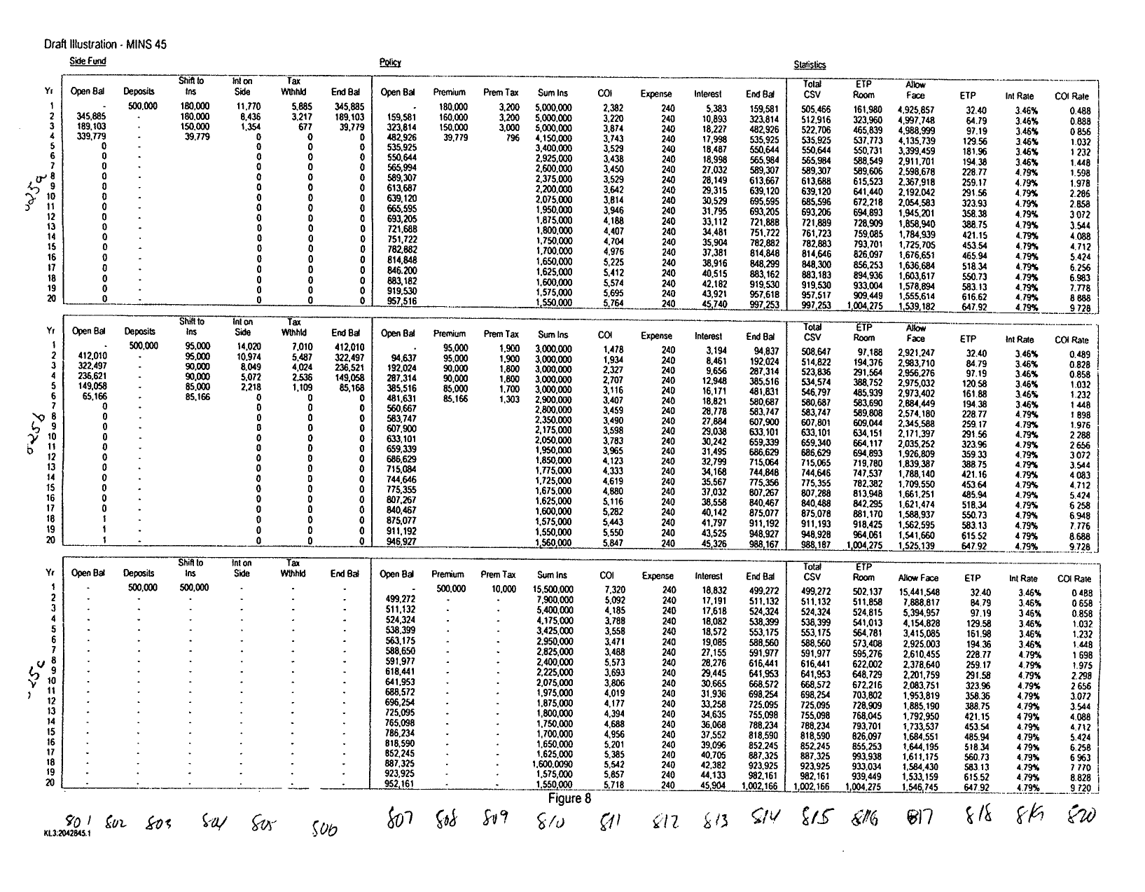

FIG. 8 shows an exemplary universal life insurance policy illustration for a 45 year old male non-smoker according to an embodiment of the present invention. In an exemplary embodiment of the present invention, each insurance company issuing an insurance policy purchased by a RCA trust account is a highly rated insurance company according to industry standards, such as a AAA-rated insurance company. As is known in the art, the Exemption Test Policy (ETP) represents the amount of money that can be invested in an insurance policy per $1000 of face amount of insurance. The ETP is calculated per applicable regulations, such as the Canadian Income Tax Act. Column 818 shows the ETP for this particular illustration. The ETP will vary by, for example, the age of the insured as well as the term of the policy. Thus, the ETP indicates the amount of money that can be placed into the insurance policy and remain free of accrual taxation. For example, in year 10, $323.98/$1000 face amount of insurance can be brought into the insurance policy while in year 20, $647.92/$1000 face amount of insurance can be brought into the policy.

Column 810 illustrates the sum insured, e.g., face amount of the insurance policy. Thus, the illustrated policy at 825b starts at $5,000,000 of insurance, which is 5000 units of $1000 in face amount of insurance. Column 818 shows that $32.40 can be brought into the insurance policy for each $1000 of insurance, resulting in 5000×$32.40=$162,000.00 of EOTP Room, shown in column 516. The ending balance shown in column 814 of $159,581 indicates that the money invested in the insurance policy ($159,581) is less than the ETP Room value of column 816 and thus can grow free from accrual taxation. Accordingly, the ETP is the mechanism which identifies the amount of money that can be moved from a side account into the insurance policy and grow free from accrual taxation. Rows 825a, 825b, 825c illustrate various face amounts of insurance and years used to bring money into the insurance policy from a side account. As shown in FIG. 8, the ETP is a set value for a particular age. Accordingly, the faster that money is brought into the policy from a side account, the greater the amount of insurance needed and thus the greater the amount charged for the death benefit component and the lesser the amount available for the RCA beneficiary.

According to an exemplary embodiment of the present invention, the universal life insurance policy illustrated in FIG. 8 is purchased by RCA trust account 130 and includes the minimum death benefit (e.g., face value) that allows the contribution to the insurance policy to be invested in the policy within the desired time period. The time period can be, for example 0, 1, 3, 5 or other desired number of years to move funds from the side account into the insurance policy. The cash value and the death benefit are owned by the RCA trust account.

In this alternative embodiment, because the owner of the insurance policy is only the RCA trust account 130, the RCA Trust is able to realize a portion of the benefits of the favorable tax treatment of the insurance company's investment income on the fund value of the insurance policy, thus allowing the fund value of the insurance policy to grow at a faster rate. In contrast, the prior art split dollar policy owned by a RCA Trust is not able to obtain similar favorable tax treatment.

Referring again to FIG. 8, 825b illustrates a universal life insurance policy having a face amount of $3,000,000 for a $1,000,000 RCA. As shown in column 810, the face amount of insurance starts at $3,000,000 and decreases to $1,550,000 at year 20 since less insurance is needed once all of the money from the side account has been moved into the policy and the ETP Room (column 816) increases each year. Assuming a $900,000 loan in the RCA transaction according to an embodiment of the present invention, the death benefit of the universal life insurance policy is always greater than the outstanding loan amount. Thus, the universal life insurance policy itself covers the obligations owed to lenders in the event of death of the insured and Investco does not need any further death benefit to cover liability from a default of the RCA loan.

However, Investco may require a term insurance policy for estate planning purposes or if required by the lending institution as part of the RCA transaction. For example, Investco may want insurance to pay off the loan owned to the RCA trust. Investco's insurance policy, however, is not necessary to facilitate the leveraged RCA loan transaction according to an embodiment of the present invention. As shown, in column 815, the CSV of the insurance policy remains greater than the initial deposit into the insurance policy ($500,000) as required to facilitate the leveraged RCA loan transaction.

Additional variations on the RCA structure according to an embodiment of the present invention relate to executive compensation. For example, in an embodiment of the present invention, the loan from Investco to Opco can utilize a convertible debenture that is convertible at the option of Opco, not Investco. The RCA trust would not vest in the beneficiary for a period of years as described by Opco. The debenture would be convertible to common stock of Opco and the conversion price could accelerate by, for example, the after-tax interest cost on the debenture.

According to another exemplary embodiment of the present invention, the RCA leveraged loans made by various lending institutions to various RCA trusts can be combined, for example in bundles of $100,000,000 or $150,000,000 total loan values and used to secure debt instruments offered to the public through the capital markets. For example, commercial paper or bonds with a minimum investment grade rating can be privately or publicly offered via a Special Purpose Vehicle (SPV) and secured primarily by the RCA loans together with the collateral, such as (i) the CSV of insurance policies used in the RCA loans and (ii) the right to monies received in a RCA trust from a refundable tax account, supporting these loans. Creating debt instruments secured by the pooled leveraged RCA loan provides a supply of debt instruments backed by high quality assets and allows investors to obtain indirect exposure to highly rated insurance companies.

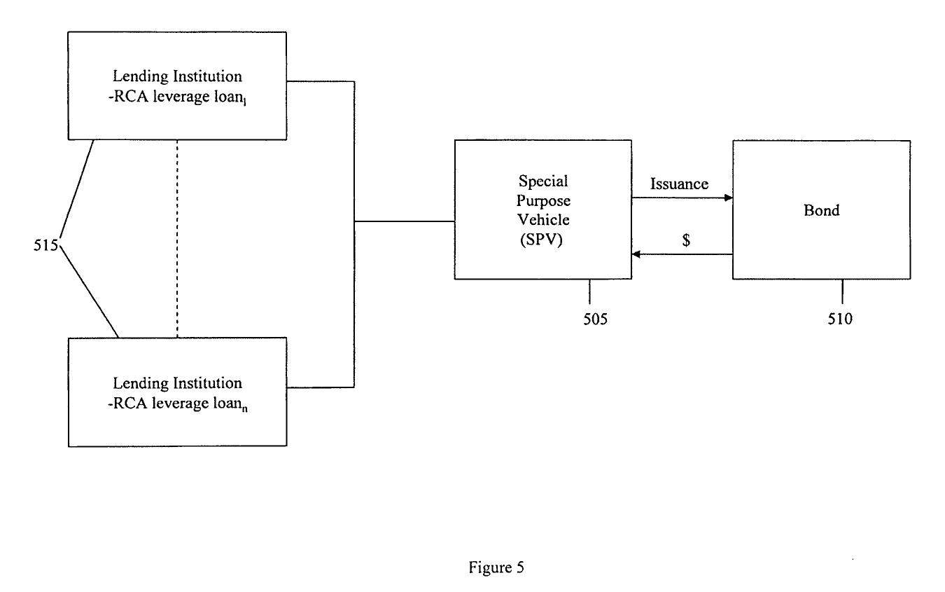

FIG. 5 illustrates an exemplary model for arranging a public or private offering of notes secured by RCA loans according to an embodiment of the present invention. As shown in FIG. 5, lending institutions 515 each make leveraged loans to RCA trust accounts as described above, secured by the right to monies received from the refundable tax account for each RCA trust and the CSV of the universal life insurance policy purchased by each RCA trust account. A special purpose vehicle (SPV) 305, such as a partnership or other suitable legal entity, purchases the notes from the originating lending institutions 510 and bundles the leveraged loans together in desired amounts, such as $100,000,000. The loans may be initially warehoused as demand loans until sufficient volume exists for securitization.

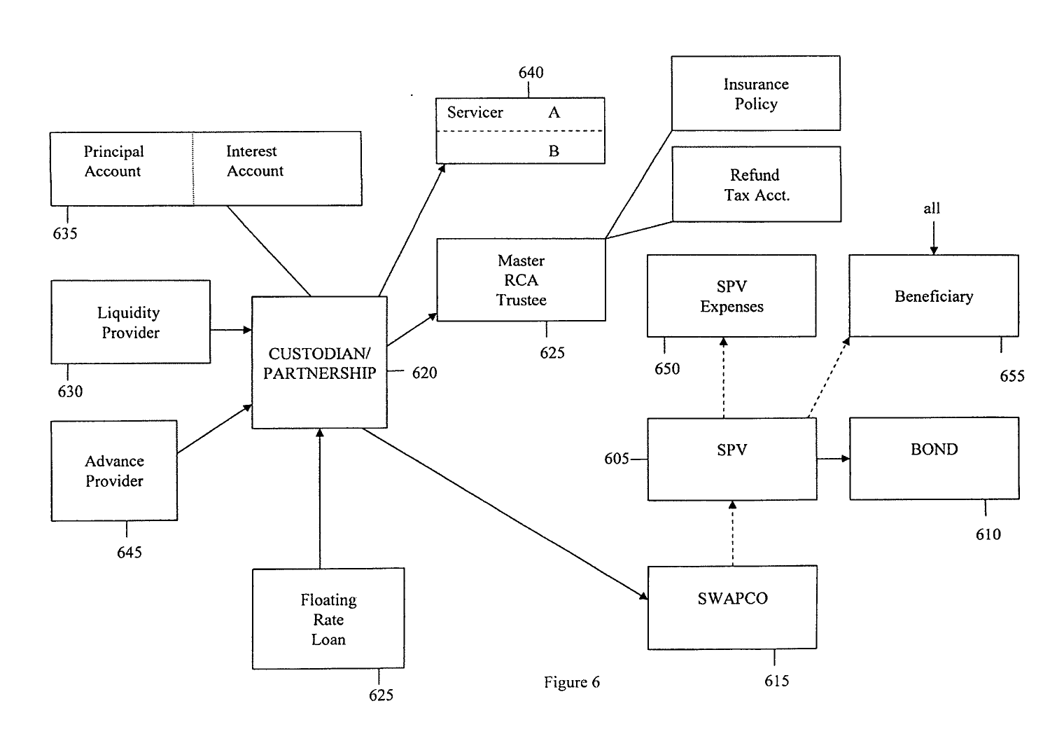

The loans can be, for example, 10 year loans at floating rates which are converted to fixed rates and fixed rate 10 year bonds issue. Alternatively, floating rate bonds could be issued or the loans could be 5 year loans at floating rates with a 5 year extension from which commercial paper is issued through a conduit. The SPV 505 can then issue bonds 510 via a public or private offering. The proceeds from the issuance of the bonds are returned to the SPV which deposits the proceeds with a custodian to make debt service payments on the loans to the agents for the lending facility and which oversees the administration of the loan portfolio for the duration of the term of the issued bonds, as described in more detail with respect to FIG. 6.

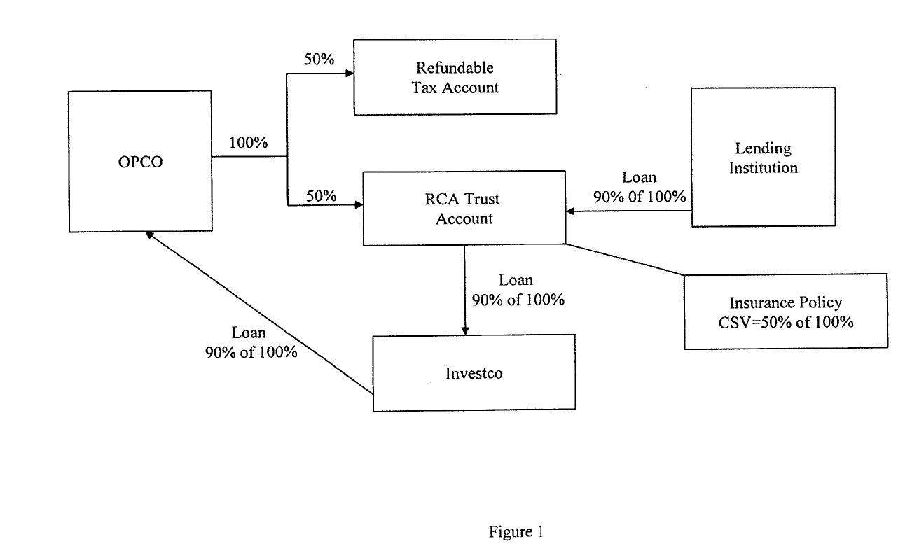

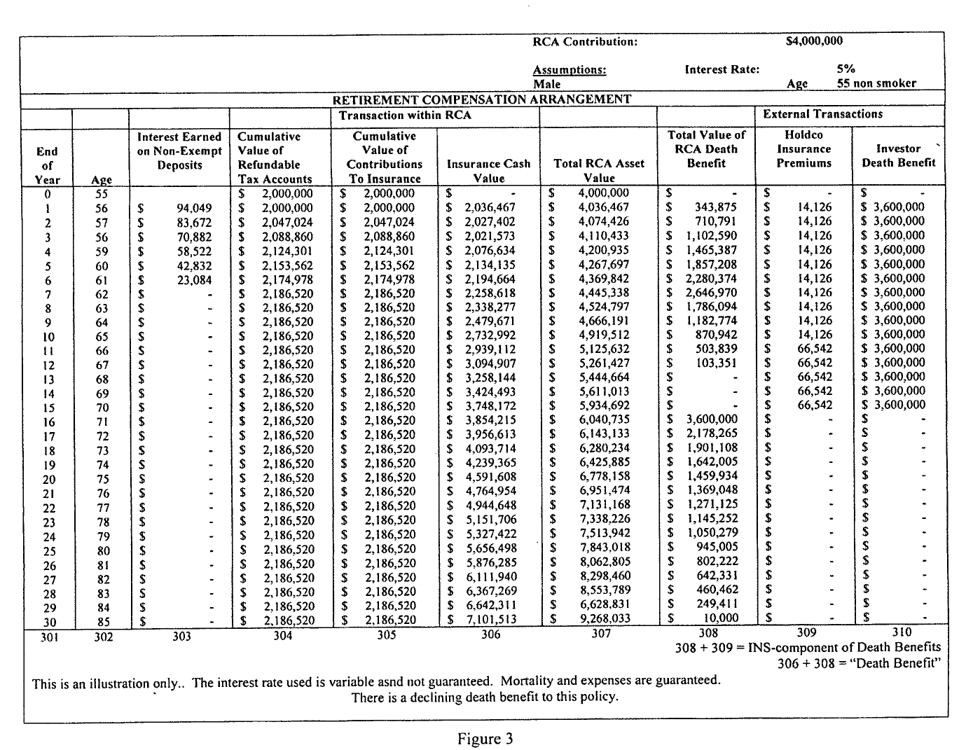

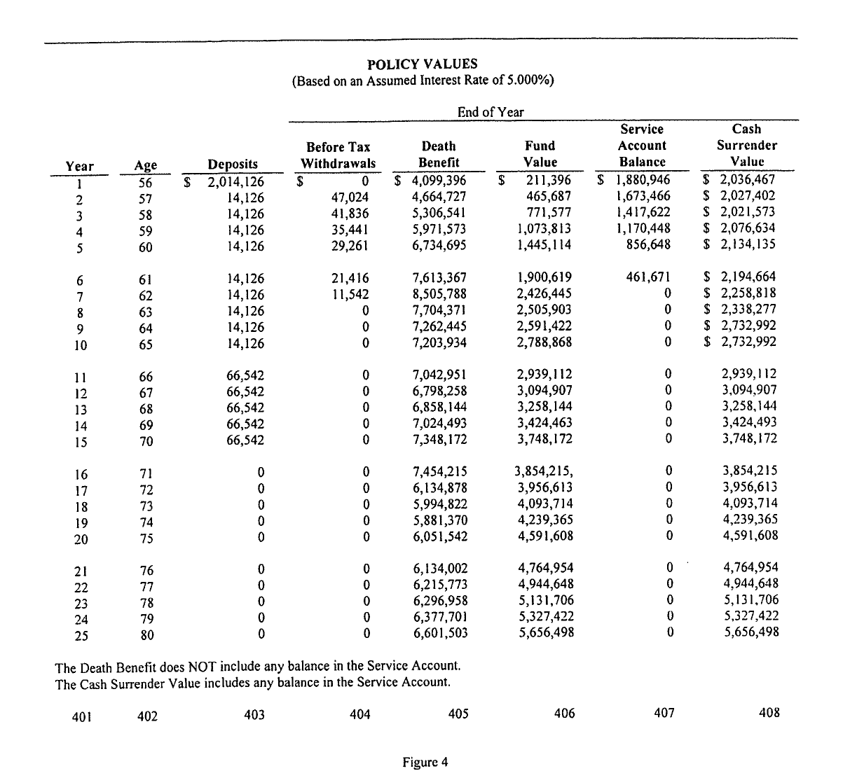

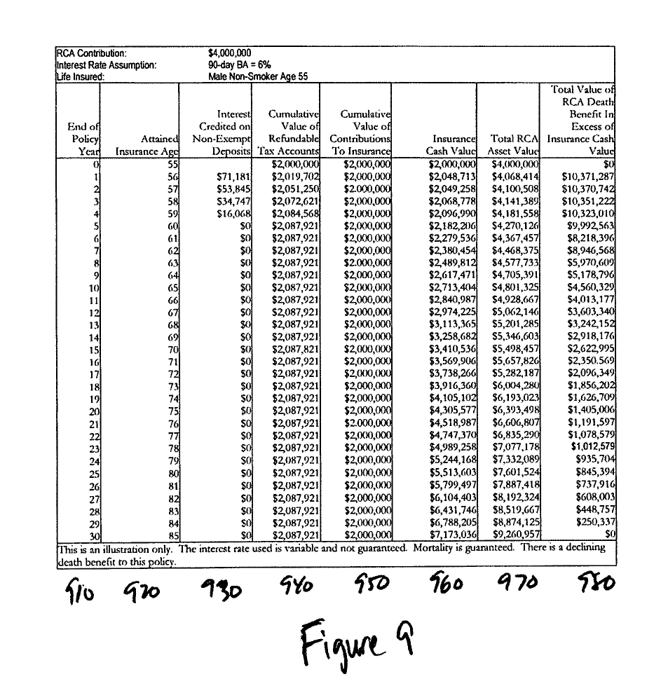

FIG. 6 illustrates an exemplary model for securitization of debt instruments using leveraged RCA loans according to an embodiment of the present invention. For example, assume that an Opco as described in FIG. 1 makes a RCA distribution and the resultant RCA trust account acquires a universal life insurance policy. The universal life insurance policy may have, for example, the characteristics described in FIGS. 3 and 4 or the characteristics described in FIGS. 8 and 9 according to an embodiment of the present invention. In an exemplary embodiment, the universal life insurance policy has a death benefit selected to allow the entire contribution from Opco to be invested in the policy within five years from policy inception. Other time periods to move all of the contribution from Opco into the policy can be utilized as desired. Having acquired a suitable universal life insurance policy, the RCA trust then obtains, for example, a loan from a lending institution for about 90% of the total distribution from Opco, the loan being secured by the CSV of the universal life insurance policy and a right to recover monies refunded from the refundable tax account.

At this point, as shown in FIG. 6, the SPV 605 acquires various RCA leveraged loans from lending institutions, for example $100,000,000 in loan amounts, and offers debt instruments secured by the RCA loans through an investment dealer or placement agent 610, for example via a public or private offering. The private or public offering can occur in the United States capital markets or other financial exchanges, such as in Canada. SPV 605 can be established, for example, as a single purpose trust, whose sole beneficiary will be a charity or non-profit organization 655. The business of SPV 605 will include raising funds by issuing notes (e.g., secured debt instruments) and investing in securitization partnerships such as custodian or partnership 620. SPV 605 will require a trustee (the “SPV Trustee”) to establish it as a trust as well as a party to provide all administrative services to the trust.

Continuing with the prior example, assume that twenty-five (25) $4,000,000 RCA transactions are bundled together, thus resulting in $100,000,000 of assets (e.g., the sum of the CSV of insurance policies and rights to monies received from the refundable tax accounts) securing approximately $90,000,000 in loans from lending institutions. The terms of the debt instruments that can be backed by the RCA collateral are, for example, ten (10) years interest only principal payable at maturity. According to an exemplary embodiment of the present invention, SPV 605 may issue $91,500,000 of debt instruments, using $90,000,000 to pay off the loans purchased from the original lending financial institutions and using the remaining $1,500,000, to pay, for example, administrative expenses 650 associated with facilitating the transaction. Examples of administrative expenses 610 include, for example, Trustees Fees, Servicing Fees Rating Agency Fees, legal expenses, underwriters compensation and other costs of issuance. The SPV's 605 interest in the debt instruments sold by market maker 610 is then passed, for example, to a custodian or partnership 620.

The custodian or partnership 620 facilitates operation of the transaction according to an embodiment of the present invention from the issuance of the debt instruments until their retirement. As described above, partnership 620 can be a securitization partnership. For example, it will purchase a certain number of RCA Loans from a number of Loan Originators pursuant to a RCA Loan Purchase Agreement on, for example, a “true sale” basis with no recourse to the Loan Originators other than for breach of representations, warranties and covenants. It will fund the purchase by, for example, a capital contribution from SPV 605.

Collections on the loans will be distributed, for example, monthly to the partners in accordance with a partnership agreement. The partnership agreement will also, for example, allocate net income and losses so that the net income allocated to SPV 605 each year will exactly equal SPV 605 interest and other expenses. For example, each month, custodian 620 receives a floating rate interest payment 625 from each RCA trust pursuant to the terms of the original loan agreement between each RCA trust and its lending institution. The floating rate loan payment 625 can be set for each RCA trust monthly or, for example, quarterly based on the 3 month Bankers Acceptance (BA) rate or other suitable benchmark. The floating rate payments received by Custodian 620 are then forwarded to Swapco 615 which, in a conventional manner, converts the floating rate payments into fixed rate payments which then flow to SPV 605 for payment to holders of the debt instruments. Swapco 615 is, for example, a swap counterparty acceptable to rating agencies who will swap, for example, BA rate plus a spread on a notional amount equal to the principal balance of RCA Loans from time to time for the fixed rate under the SPV Trust notes.

A number of legal entities assist (e.g., additional service providers) Custodian 620 in carrying out the transaction according to an embodiment of the present invention. For example, a Liquidity Provider 630 undertakes, in the event of a default on a loan by an Opco, to advance money from the refundable government tax account needed for debt service into the Principal Account and Interest Account 635. In this circumstance, the Liquidity Provider 630 will advance the funds needed for debt service and separately seek repayment of monies from the refundable tax from the appropriate RCA trust account.

The Liquidity Provider 630 can be a subsidiary of, for example, a financial institution who will enter into a credit derivative contract with partnership 620 to advance the lesser of (i) the amount of any refundable tax relating to a RCA Loan where the Opco has become insolvent and the refundable tax has not been received by partnership 620 prior to the maturity date of the SPV Trust notes and (ii) the outstanding obligations under the RCA Loan. The Liquidity Provider 630 will receive from partnership 620, for example, a periodic fee and a return of all refundable tax when received by custodian 620. In order to ensure that custodian 620 is in a position to pay over all such refundable tax to the Liquidity Provider 630, the RCA Loans will have to be amended to provide that on default the Borrower will pay, as liquidated damages, the amount of any refundable tax that would otherwise constitute surplus collateral for the RCA Loans where such refundable tax is not received by a specified date.

Similarly, a Master RCA Trustee 625 is legally authorized to take action with respect to the insurance policy owned by the RCA trust or the refundable tax account as necessary to retrieve monies needed to pay interest or principal to holders of the debt instruments. For example, all of the RCA Trusts participating in the securitization can be amended to designate the RCA Master Trustee, which can be an institutional trust company, as trustee of each of the RCA Trusts. Among other things, the RCA Master Trustee 625 will acknowledge that the right to monies retained from the refundable tax securing the RCA Loans has been assigned to custodian 620 and will agree to pay over to custodian 620 all refundable tax received by it as soon as it is received.

A principal and interest account 635 is maintained by Custodian 620 and is used, for example, upon default, death or insolvency of an insured or an Opco. For example, upon death of a beneficiary of a RCA trust account, a death benefit from the insurance policy would be paid and would be used to pay the principal owed on the loan due to the Custodian 620 and also used to pay back the owner of the debt instruments. Accordingly, the death benefit payment could be held in the principal portion of the account 635 while interest earned on the principal amount (e.g., from reinvestment) could be held in an interest portion of the account 635 to offset any negative carry that may exist due to the differential in interest payments owed to debt holders and interest earned on the principal amount from the defaulted loan.

Also assisting the custodian 620 in the case of default by an Opco is Advance Provider or Special Servicer 645. The Advance Provider 645 provides payments, for example monthly, to Custodian 620 in the case of, for example, delinquency in payment by an Opco. A Servicer 640 performs certain administrative tasks for Custodian 620, such as, for example, sending out statements to Opcos or RCA trusts or tracking payments from Opcos or RCA trusts. In addition, the Service 640 may monitor performance of underlying insurance policies to ensure, for example, that each policy is performing in accordance with its expected values.

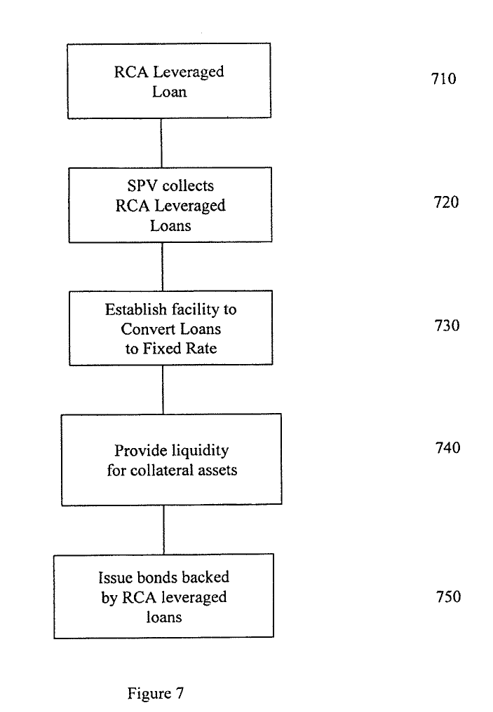

FIG. 7 illustrates an exemplary method for the securitization and offering of debt instruments backed by RCA leveraged loans according to an embodiment of the present invention. Referring to FIGS. 6 and 7, at 710 RCA leveraged loans are obtained by RCA trust accounts as described above. At 720, the leveraged RCA loans from various lending institutions are purchased by, for example, partnership 620 using funding from SPV 605 and bundled together in desired quantities.

At 730, the bundled RCA leveraged loans are converted from floating rates originated by the lending institutions 515 to a fixed rate obligation. The fixed rate obligations are necessary, for example, to fix the value of the loan portfolio in order to offer medium term debt fixed rate instruments in a public or private offering. One approach to obtain a fixed rate loan based on the various floating rate RCA loans is to utilize the swap market. As is known in the art, an intermediary in the marketplace, often referred to as a swap counterparty or Swapco, will accept a stream of floating rate payments and provide a stream of fixed rate payments. Thus, according to an embodiment of the present invention as shown in FIG. 6, Swapco 615 converts the floating rate cash flow to a fixed rate cash flow. Accordingly, the SPV 605 now has a fixed rate investment to offer to the bond market 610. A principal and interest account 635 also may be established to hold any interest and principal payments on the SPV assets (e.g., the leveraged RCA loans) received by the SPV prior to the scheduled distribution of principal to the bondholders.

To further facilitate marketplace acceptance of the debt instruments collaterized by RCA leveraged loans, the liquidity of the collateral must be addressed. The Liquidity Provider 630 or a cash reserve account provides for protection of investors in the event of default on loans backing the issued debt instruments. For example, since part of the collateral includes the refundable tax account maintained by Revenue Canada, a note holder may not want to have to pursue payment on the defaulted note directly from Revenue Canada, particularly where the recovery process from the refundable tax account may be difficult and/or protracted. Thus, according to an embodiment of the present invention, a Liquidity Provider 630 may be provided at 740 to act as an intermediary between the refundable tax account and the owners of the secured debt instruments. In an exemplary embodiment of the present invention, the liquidity provider, such as financial brokerage facility, may assume an obligation to advance any delinquencies to the SPV and pursue defaulted amounts owed from refundable tax accounts, even after the term of the debt instrument, so that holders of defaulted debt instruments can be repaid and do not have to pursue payment from the refundable tax account.

At 750 debt instruments are issued via a public or private offering. The debt instruments are secured by the leveraged RCA loans according to an embodiment of the present invention. As shown in FIG. 6, SPV 605 provides the proceeds of the issuance of the debt instruments to a Custodian 620. As a result, every month Custodian 620 receives an interest payment 625 from each Opco, resulting in a cash flow. For the purposes of issuing bonds based on an amalgamation of the loans to various RCA trust accounts by various institutions, each of the floating rate loan payments 625 flows through Swapco 615 to generate the fixed rate payments needed for the bondholders. In an alternative embodiment of the present invention, commercial paper can be offered instead of bonds.

According to another exemplary embodiment of the present invention illustrated in FIG. 9, the CSV of the universal life insurance policy contract utilized in a leveraged RCA loan transaction can be enhanced by the fund value growing at a floating rate, for example, based on Bankers Acceptance (BA) rate or LIBOR, instead of a fixed rate. In addition, the universal life policy can provide a greater payment to the fund value upon default of the RCA loan and involuntary surrender of Opco, thereby offsetting any negative carry that the issuer of securitized debt may experience throughout the term of the program. Involuntary surrender includes, for example, suicide of the insured within the suicide exclusion period, seizure of the policy by the collateral assignee, voiding of the policy due to a misrepresentation during the contestable period or default on the loan by Opco. Such a circumstance is undesirable when the RCA loan and insurance policy are used to secure a debt instrument.

As shown in FIG. 9, death of the insured would cause the death benefit of the policy, shown in column 980, to be paid to the beneficiary of the insured, the RCA trust. In the case of default and involuntary surrender of the policy, however, the total CSV shown in column 960, including the Fund Value and Side Fund, also are paid to the collateral assignee. Normally, there would not be a payment from the insurance policy in such a circumstance. For example, in the event of death during the suicide exclusion period, or denial of benefits due to misrepresentation, or seizure of the policy by the collateral assignee, instead of the claim under the policy being denied, the CSV that applies on involuntary surrender would be paid.

According to an embodiment of the present invention, the CSV can be set to be the higher of the actual CSV or a predetermined amount. The predetermined amount can be set by, for example, the insurance carrier and is designed to account for negative carry that could arise due to undercollaterization at the time of default when the RCA loan is bundled together with other RCA loans and used to back debt securities sold in public or private offering, as described above. For example, upon involuntary surrender of the insurance policy and a default on an RCA loan, an additional CSV amount can be paid (e.g., an additional amount beyond the CSV shown in FIG. 9). Thus, the CSV on involuntary surrender and default on the RCA loan an be sufficient to retire the corresponding RCA loan net of the refundable tax account amount and, for example, any recoveries obtained by a loan servicer. Similarly, the CSV formula can provide for any differences in the cost of carrying commercial papers and the return on its assets which recovery is sought from amounts received from the refundable tax account.

Additionally, in the event of default by Opco and involuntary surrender by the insurance policy, a deferred annuity can be made available earning a fixed rate (e.g., BA or LIBOR). The involuntary CSV formula can contemplate such an annuity to hold proceeds from the involuntary surrender CSV. For example, the CSV formula could account for a variety of factors, including: (i) a base CSV of the insurance policy is deposited in the annuity policy upon involuntary surrender; (ii) interest is credited on the annuity policy at the predetermined rate; (iii) withdrawals are made from the annuity to pay interest to the lender; (iv) withdrawals are made from the annuity to pay interest accrued on loan balance owed by OPCO; (v) program costs; and (vi) an additional payment will be made if the balance of the annuity policy falls below the outstanding loan balance less the amount of the refundable tax account. Thus, most of the default risk can be removed from SPV 605 other then money not being refunded from the refundable tax account according to an embodiment of the present invention.

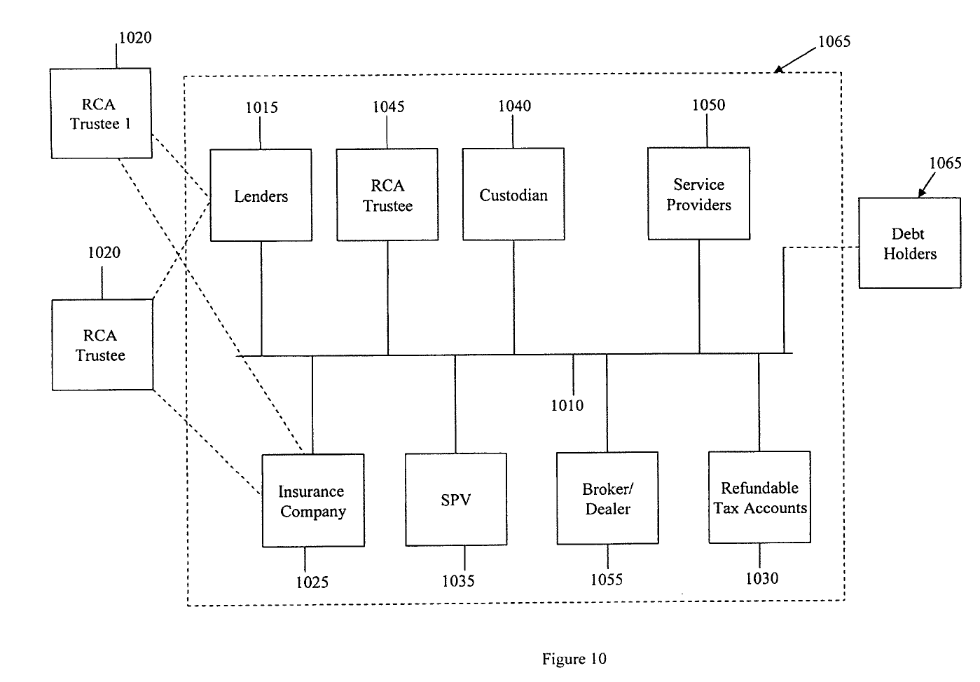

FIG. 10 illustrates another embodiment for offering debt securities in accordance with the present invention. As will be appreciated by those of ordinary skill in the art, the method for arranging RCA loans and aggregating these RCA loans to secure debt instruments to be sold in a public or private offering can be implemented in a variety of ways. For example, the method can carried out manually with each entity involved in the transaction manually performing actions such as originating the RCA loans, issuing the insurance policies to the RCA trust accounts, acquiring a plurality of RCA loans to secure debt instruments to be created and sold by a broker/dealer and servicing the payments on the loans and to the debtholders. The function of each entity that can be manually implemented is described in greater detail with regard to FIG. 6. In addition, multiple functions can be performed by a single entity if desired. For example, the broker/dealer also could perform the function of the liquidity provider.

In another embodiment of the present invention, however, some or all of the functions can be implemented in a computer system as shown in FIG. 10. For example, a variety of computer systems carrying out the various functions involved in offering debt securities according to an embodiment of the present invention can be connected to a communications link 1010. As will be appreciated by those of ordinary skill in the art, software to be stored in and executed by the computer systems can be written in conventional programming languages such as C++, JAVA, HTML or other known languages. In addition, known software applications such as electronic spreadsheets and relational databases can be used to carry out aspects of the present invention.

The communications link 1010 can include, for example, a proprietary dialup connection, a public network such as the Internet or world wide web, a local area network (LAN) or wide area network (WAN). In addition, the communications link can include wired, wireless or optical links, including combinations thereof as is known in the art. In an alternative embodiment, a single computer system, or a distributed network can carry out the various functions involved in offering debt securities according to an embodiment of the present invention.

FIG. 10 shows the various entities or functions involved in the RCA loan-backed debt instrument offering connected to the communications link 1010. Each entity or functionality can connect to the link 1010 in any desired manner, various entities using different connection protocols if desired. For example, lender 1015, such as banks or financial institutions originating RCA loans, are coupled to communications link 1010. As is known in the art, lenders can provide, for example, an on-line loan application process to handle, for example, RCA trust accounts desiring a RCA loan as described above. Alternatively, the lenders 1015 can receive loan request information manually or in other ways and process the loan request on the lender's computer system. For example, a lender 1015 can utilize a server, such as a SUN MICROSYSTEMS workstation or suitable microprocessor-based computer system, to process loan requests through to closing of the RCA loan to a RCA trust 1020. As described above, the Opco in accordance with an embodiment of the present invention. As will be appreciated by those skilled in the art the loans to amount of Investco and to Opco also can be performed electronically, the RCA loan can be loaned from the RCA Trust to an intermediary, referred to as Investco, who in turn makes a loan.

If desired RCA trusts 1020 can also have manual or electronic interaction with insurance companies 1025 to acquire, for example, universal life insurance policies contemplating the RCA loan and subsequent securtization in accordance with an embodiment of the present invention. Like the lenders 1015, insurance companies 1025 can support on-line processing of applications for insurance policies, as is known in the art, or they can support manual applications for insurance and subsequent processing of the request using conventional computer systems. For example, a SUN MICROSYSTEMS workstation or suitable microprocessor-based computer system can be used to generate process application information, generate insurance policy illustrations and issue insurance policies. Various software applications to generate insurance policy illustrations and insurance policies are well known in the art and are not further described herein. Insurance companies 1025 can connect to the communications link 1010 in any desired manner, for example using an Internet Service Provider (ISP) to access the world wide web and interact with customers, such as RCA trusts 1020, as well as with other parties involved in the RCA loan and securitization transaction according to an embodiment of the present invention.

Refundable tax accounts 1030 are created as part of the RCA transaction underlying the offering of debt instruments backed by the RCA loans and may be connected to the communications link 1010 so that, for example, funds can be wired or electronically transferred into and out of the refundable tax account. Additionally, the status of the refundable tax account could be checked via the communications link 1010. This capability can be provided, for example, using a server or suitable microprocessor-based computer system to track the status of refundable tax accounts held by Revenue Canada (e.g., in a conventional database) and allow access to the server or computer system to query the status of a particular account in a conventional manner.

As described earlier, once the RCA loan has been originated a SPV 1035 can acquire a plurality of RCA loans held by lenders 1015. For example, SPV 1035 could search for various RCA loans using conventional methods, e.g., voice communications with various lenders to determine if any RCA loans were available for purchase, or electronic methods using, for example, communications link 1010. For example, SPV 1035 can communicate electronically with lenders 1015 via e-mail or by accessing a database via, for example, the Internet or proprietary connection, of one or more lenders to determine if any RCA loans having criteria acceptable to the SPV 1035 are available for purchase. The electronic communications between SPV 1035 and lenders 1015 can be accomplished in this manner using, for example, respective workstations, servers or suitable microprocessor-based computer systems that can communicate with one another in a conventional manner. In addition, SPV 1035 can negotiate and purchase the desired RCA loans electronically if desired or conduct manual (e.g., in-person) negotiations to acquire the desired RCA loans.

Once SPV 1035 has acquired the desired RCA loans, a custodian 1040, described previously, can communicate with SPV 1035 via communications link 1010. Custodian 1040 can connect to communications link 1010 in any desired manner, such as through an ISP or a proprietary connection. The various functions of Custodian 1040, such as administering the RCA loan portfolio acquired by SPV 1035, including, for example, receiving monthly floating rate loan payments from Opcos, interfacing with a swap counterparty (who also may be connected to Custodian 1040 via communications link 1010) and reporting administrative information to SPV 1035, may be accomplished electronically using, for example, a suitable microprocessor-based computer system to receive, process and transmit information. Alternatively, some information, such as loan payments, may be received in non-electronic form (e.g., cash in the mail) and corresponding electronic information stored into the memory or database of Custodian 1040 by an operator of the computer system.

If the SPV 1035 desires to offer debt instruments secured in part by the RCA loans acquired by the SPV 1035, then a broker/dealer 1055, such as a brokerage house or financial institution authorized to trade in securities, can communicate with SPV 1035 and/or custodian 1040 via communications link 1010 to obtain the necessary information on the portfolio of RCA loans to be used to secure the debt instruments. For example, a database containing all of the pertinent information on the RCA loan portfolio, including, for example, digital images of the loan papers for each loan, can be stored by the custodian 1040 or SPV 1035 and made available to broker/dealer 1055. For example, the database can be electronically shipped to broker/dealer 1055 or electronically accessed by broker/dealer 1055 and desired information downloaded from the database. As discussed before, the communication link 1010 utilized by the broker/dealer 1055 can be, for example, the Internet or a proprietary network. Once broker/dealer 1055 has the necessary information, the security instruments can be drafted, for example using the computer system of broker/dealer 1055 in a conventional manner, including obtaining all necessary regulatory and governmental agency approvals. Once the broker/dealer 1055 has prepared the debt instruments backed by the RCA loans, then the broker/dealer 1055 can conduct a private or public offering of the debt instruments in a conventional manner, including, for example, an on-line offering of the debt instruments to debt holders 1060.

As part of the method for securitizing the portfolio of RCA loans according to an embodiment of the present invention, RCA Master Trustee 1045 is utilized as described with regard to FIG. 6. As shown in FIG. 10, RCA Master Trustee 1045, including an administrator 1047, can be connected to communications link 1010 to provide electronic access to the RCA Master Trustee 1045. Particularly, in the event of a default condition on the RCA loan, and the custodian 1040 may request that the RCA Master Trustee 1045, via administrator 1047, seek the refund of monies from the refundable tax account. The functions to be performed by RCA Master Trustee can be hosted and performed using, for example, a conventional microprocessor-based computer system which can connect to the communications link 1010.

As described with regard to FIG. 6, several additional entities can be utilized to carry out the offering of debt instruments backed by RCA loans according to an embodiment of the present invention. For example, service providers 1050 can include any or all of the various entities or functions, such as a liquidity provider, advance provider, servicer or principal and interest account shown in FIG. 6 and described in the accompanying text. In addition, each of the service providers 1050 can communicate with other service providers 1050 or the other entities (e.g., SPV 1035 or custodian 1040) using communications link 1010, thereby providing a computer network-based implementation of the system and method for offering debt instruments backed by RCA loans according to an embodiment of the present invention. Alternatively, some or all of the service providers 1050 can support non-electronic communications (e.g., manual) as well as electronic communications. In an alternative embodiment, a single computer system or network 1065, including, for example, a distributed network, can be utilized to implement the system for offering debt instruments backed by RCA loans according to an embodiment of the present invention. Additionally, the various functions illustrated in FIG. 10 can be on separate computer stations in a distributed network. Also, various entities may implement one or more of the functions.

What is claimed is:

1. A method for offering a debt security, comprising:
aggregating a plurality of RCA loans;
creating a plurality of debt securities backed by the plurality of RCA loans; and
selling the plurality of debt securities in an offering.

2. The method of claim 1, wherein the offering is one of a private offering and a public offering.

3. The method of claim 1, wherein each of the RCA loans is created relates to:
a distribution from a first party to a RCA account and to a refundable tax account, an amount of the distribution being equally divided between the RCA account and the refundable tax account;
an insurance policy owned by the RCA account and having a cash surrender value at least as great as the amount of the distribution to the RCA account;
a first loan from a lending party to the RCA account, the first loan having a value equal to a predetermined percentage of the distribution, the first loan being secured by the insurance policy and a right to monies recovered from the refundable tax account;
a second loan from the RCA account to an intermediary party, the second loan having a value substantially equal to the value of the first loan; and
a third loan from the intermediary party to the first party, the third loan having a value substantially equal to the value of the first loan.

4. The method of claim 3, wherein the insurance policy includes a universal life insurance policy.

5. The method of claim 4, wherein the universal life insurance policy includes a first cash surrender value and a second cash surrender value greater than the first cash surrender value, wherein upon a default condition of a respective one of the plurality of RCA loans, the second cash surrender value is used to offset a negative carry condition.

6. The method of claim 1, wherein each of the plurality of RCA loans is secured by an insurance policy and each of the plurality of debt securities provides an investment in a claims-paying ability of each insurance company issuing the insurance policy.

7. A system for offering a debt security, comprising:
a special purpose vehicle computer;
a custodian computer connected to the special purpose vehicle computer via a communication link; and
a broker/dealer computer connected to the communications link;
wherein the special purpose vehicle computer includes computer readable program code causing the special purpose vehicle computer to aggregate a plurality of RCA loans and to transfer data on the plurality of RCA loan to the custodian computer and to the broker/dealer computer, the custodian computer including computer readable program code causing the custodian computer to administer the plurality of RCA loans, the broker/dealer computer including computer readable program code causing the broker/dealer computer to create a plurality of debt securities backed by the plurality of RCA loans and to sell the plurality of debt securities in an offering.

8. The system of claim 7, wherein the administration of the plurality of RCA loans by the custodian computer includes receiving periodic payments for the plurality of RCA loans.

9. The system of claim 7, wherein the plurality of debt instruments includes one of a bond and a commercial paper.

10. The system of claim 7, comprising:
a lender computer coupled to the communication link; and
an insurance company computer coupled to the communication link;
wherein the lender computer includes computer readable program code causing the lender computer to originate at least a respective one of the plurality of RCA loans and the insurance company computer includes computer readable program code causing the insurance company computer to issue an insurance policy related to a respective one of the plurality of RCA loans.

11. The system of claim 10, comprising:
a master RCA trustee computer coupled to the communication link, the master RCA trustee computer including computer readable program code causing the master RCA trustee computer to administer a respective RCA trust of each of the plurality of RCA loans.

12. The system of claim 11, comprising:
an additional service provider computer coupled to the communication link, the additional service provider computer including computer readable code causing the additional service provider computer to perform at least one of a set of predetermined functions, the set of predetermined functions including functions of a liquidity provider and an advance provider and a swap counterparty.

13. The system of claim 7, wherein the communication link provides access to a plurality of debtholders and to a plurality of RCA trusts.

14. The system of claim 7, wherein the communication link includes one of an internet network link, a proprietary dial-up network link, a local area network link, a wide area network link, an optical fiber network link and a wireless network link.

15. The system of claim 7, wherein each of the plurality of RCA loans relates to:
a distribution from a first party to a RCA account and to a refundable tax account, an amount of the distribution being equally divided between the RCA account and the refundable tax account;
an insurance policy owned by the RCA account and having a cash surrender value at least as great as the amount of the distribution to the RCA account;
a first loan from a lending party to the RCA account, the first loan having a value equal to a predetermined percentage of the distribution, the first loan being secured by the insurance policy and a right to monies recovered from the refundable tax account;
a second loan from the RCA account to an intermediary party, the second loan having a value substantially equal to the value of the first loan; and
a third loan from the intermediary party to the first party, the third loan having a value substantially equal to the value of the first loan.

16. A system for offering a debt security, comprising:
a special purpose vehicle (SPV) acquiring a portfolio of floating rate RCA loans;
a custodian managing the portfolio of RCA loans for the SPV;
an agent of the SPV facilitating a sale of debt instruments secured by the portfolio of RCA loans; and
a swap counterparty connected to the custodian, the swap counterparty converting payment from the portfolio of floating rate RCA loans to a stream of fixed payments for providing payment to holders of the debt instruments.

17. The system of claim 16, comprising an additional service provider connected to the custodian, the additional service provider including one of a liquidity provider, an advance provider and a servicer.

18. The system of claim 17, comprising a master trustee connected to the custodian, the master trustee being legally authorized to seek monies refunded from a refundable tax account of a respective one of the plurality of RCA loans.

19. The system of claim 18, comprising a principal and interest account connected to the custodian.

20. The system of claim 16, wherein each of the plurality of RCA loans relates to:
a distribution from a first party to a RCA account and to a refundable tax account, an amount of the distribution being equally divided between the RCA account and the refundable tax account;
an insurance policy owned by the RCA account and having a cash surrender value at least as great as the amount of the distribution to the RCA account;
a first loan from a lending party to the RCA account, the first loan having a value equal to a predetermined percentage of the distribution, the first loan being secured by the insurance policy and a right to monies recovered from the refundable tax account;
a second loan from the RCA account to an intermediary party, the second loan having a value substantially equal to the value of the first loan; and
a third loan from the intermediary party to the first party, the third loan having a value substantially equal to the value of the first loan.
